(19) United States
(12) Patent Application Publication
(10) Pub. No.: US 2008/0067245 A1
(43) Pub. Date: Mar. 20, 2008

(54) BASKET TAG WITH 2-D BAR CODE

(75) Inventor: Mark W. Starrett, Anna, OH (US)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 11/470,446

(22) Filed: Sep. 6, 2006

(51) Int. Cl. G06K 7/00

(52) U.S. Cl. 235/435

(57) ABSTRACT

A tag for identifying a component or a basket used in a manufacturing facility. The tag is made from a stainless steel plate and has a plurality of thru-holes formed therein. The holes are arranged in a pattern that defines a two-dimensional (2-D) bar code. The 2-D bar code can be read from a front side or a rear side of the plate using a bright-field or dark-field vision system. The tag may further include indicia such as letters, numbers, or symbols that are recognizable by humans.

### BACKGROUND OF THE INVENTION

1. Field of the Invention

The present invention is directed toward a tag for identifying a component or a basket.

2. Description of Related Art

In modern manufacturing facilities, baskets are used to hold components for storage and for collective or batch processing, such as painting, chemical treatment, heat treating, cleaning/degreasing, and the like.

As with any manufacturing process, it is desirable to have the ability to track the baskets, and hence the components held therein. By tracking the baskets and associated components, manufacturing yield rates can be calculated and various checks and quality safeguards can be introduced. While this may seem to be a simple matter, it is sometimes difficult and/or time consuming to track the baskets and components. This is many times due to the fact that the baskets and components are not uniquely identified in a permanent manner that is resistant to heat, corrosion, abrasion, paint buildup, chemicals, and/or light impact.

For example, printed tags that are attached to the baskets or components are known in the art. However, the printing on these tags loses contrast and also distorts after repeated exposure to high temperatures (at or above 1400° F.) in furnaces. This loss of contrast and distortion prevents reliable reading by commercially available vision systems. It can be appreciated that tags with any type of printing offer this potential for print degradation after repeated exposure to various substances and conditions such as heat, corrosive chemicals, abrasive substances, and/or light impact with other objects during the manufacturing process.

Therefore, there exists a need in the art for a tag that is resistant to the above performance reducing substances and conditions.

### SUMMARY OF THE INVENTION

The present invention is directed toward a tag that allows a human or a machine to identify individual baskets or components. The tag may be attached to the basket, thereby creating an identifiable bin. Alternatively, the tag may be directly or indirectly attached to a component or a group of components. The tag provides the necessary indicia so that the identifiable bin or component can be recognized and thus, tracked. In accordance with the present invention, the tag is readable by humans or by commercially available machines, such as vision systems.

### BRIEF DESCRIPTION OF THE DRAWINGS

These and further features of the invention will be apparent with reference to the following description and drawings, wherein:

FIG. 1 is a perspective view schematically illustrating a bin including a basket and a tag of the present invention;

FIG. 2 is a front view of the tag;

FIG. 3 schematically illustrates use of the tag of the present invention with dark-field lighting; and

FIG. 4 schematically illustrates use of the tag of the present invention with bright-field lighting.

### DETAILED DESCRIPTION OF THE PREFERRED EMBODIMENTS

With initial reference to FIG. 1, the identifiable bin 10 according to the present invention is shown to include a basket 12 and a tag 14. The basket 12 has a first side 16, a second side 18, a third side 20, a fourth side 22, a top 24, and a bottom 26 that cooperate to define an enclosure for receipt of components 42. The tag 14 is a metal plate 28 having machine readable indicia 30 and human readable indicia 32 formed therein.

The tag 14 is preferably formed from a heat and chemical resistant metal. Preferably, the tag 14 is formed from a stainless steel plate. The tag 14 has a front side 34 and a rear side 36 and a thickness dimension extending from the front side 34 to the rear side 36. The machine readable indicia 30 is a pattern of thru-holes 38 that cooperate to define a two-dimensional (2-D) bar code 40. The human readable indicia 32 is one or more cut-outs or thru-holes that forms a shape that is readily recognizable by a human, such as numbers, letters, and/or symbols.

In FIG. 1 the components 42 are shown placed in the basket 12. Components 42 may include gears, pistons, or any other manufacturing components that are to be stored, treated, or processed. While the basket 12 is shown to have a rectangular shape, it is understood that the basket is not restricted to any particular shape and could further utilize a lid (not shown) with placement on or around the top 24 of the basket 12. Finally, while the basket 12 is illustrated as having an open cagelike construction, it is understood that the basket 12 could be of a closed construction. It is also considered apparent that the basket 12 may be part of a wheeled vehicle or cart, and may include other structures, such as fork pockets, to facilitate lifting and moving of the basket 12, as is well known in the art.

In the illustrated and preferred embodiment, the tag 14 is located in the upper left corner of the first side 16 of the basket 12. However, other locations such as, for example, in a middle of the second side 18, are possible and contemplated. The tag 14 is attached to the first side 16 by conventional means such as, by welding or fasteners, either directly, as illustrated, or via a mounting bracket (not shown). Preferably, the tag 14 is permanently attached by welding to the basket 12. While not illustrated, it is considered apparent that the tag 14 could also be pivotally attached to the basket 12 by a hinge. It is also contemplated, though less preferred, that the tag 14 could be integrally formed with the basket 12.

As noted hereinbefore, the tag 14 is a stainless steel plate 28 having thru-holes and/or cutouts to define machine readable indicia 30 and human readable indicia 32. By providing both machine readable indicia 30 and human readable indicia 32 on the tag 14, the identity of the identifiable bin 10 or component(s) 42 can be easily ascertained either by a human or with the aid of a commercially available machine, such as a vision system.

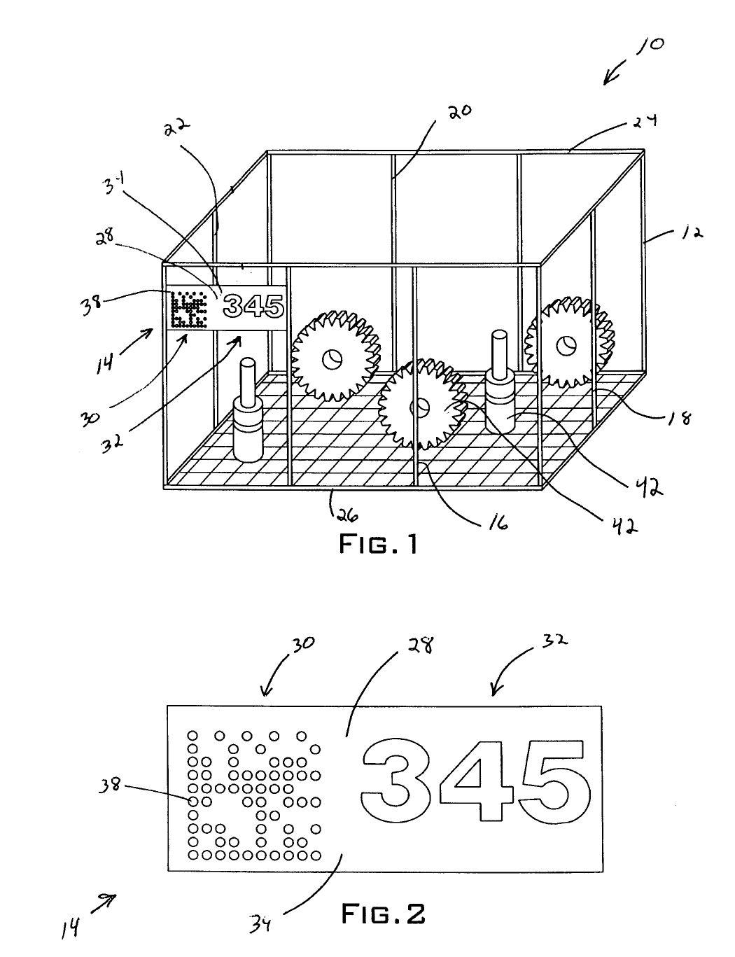

While it is preferred in most applications that the tag 14 be attached to the basket 12, the tag 14, as shown in FIG. 2, may be separate from the basket 12 and thereby be used in a stand alone configuration. In the stand alone configuration, the tag 14 may be directly or indirectly attached to an individual component 42 or to a bundle of components.

As is further shown in FIG. 2, the machine readable indicia 30 is located on a left side of the plate 28, while the human readable indicia 32 is located on a right side of the plate 28. However, the order or location of the respective indicia 30, 32 is not important. For example, the human readable indicia 32 could be located above the machine readable indicia 30. Naturally, each tag 14 will have its own individual machine-readable two-dimensional bar code and human readable indicia so as to permit identification of each individual basket 12.

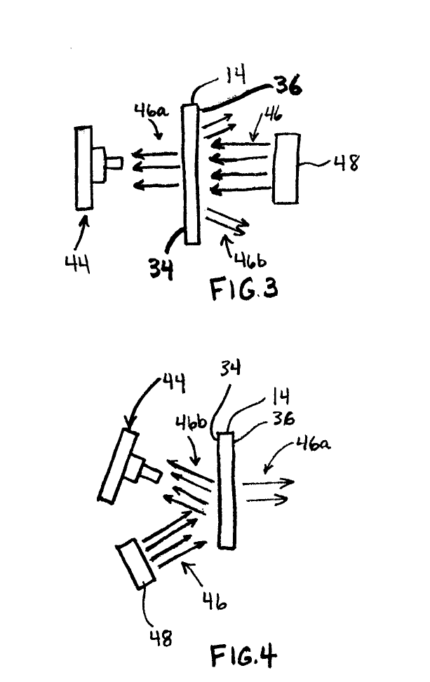

As noted previously, the machine readable indicia 30 is comprised of a pattern of thru-holes 38. The thru-holes 38 extend through the plate 28 and thus, through the front side 34 and the rear side 36 (FIGS. 3 and 4) of the tag 14. Preferably, the thru-holes are circular in shape. Naturally, it is contemplated that the thru-holes could be non-circular, such as square, with equal functionality. As the thru-holes 38 extend completely through the thickness of the tag 14, light incident on the front (or rear) can pass through the tag 14 so as to project from the rear (or front).

The tag 14, which is preferably formed from heavy gauge stainless steel, has a thickness selected to give the tag 14 the desired stiffness and rigidity, and so that the tag 14 is durable and resistant to the rather harsh environment in which the tag is used.

The pattern of the thru-holes 38 defines a two-dimensional (2-D) bar code 40 that is readable by commercially available machines, such as vision systems. While only one two-dimensional (2-D) bar code is illustrated, it is understood that the tag 14 could be configured to represent a plurality of different two-dimensional (2-D) bar codes. It is believed that two-dimensional (2-D) bar codes are well known in the art, and the concepts and advantages thereof over other methods of representing information will not be discussed at length hereinafter.

An example of using the tag 14 of the present invention with dark-field lighting is illustrated in FIG. 3, while an example using the tag 14 with bright-field lighting is illustrated in FIG. 4.

FIG. 3 includes a vision sensor 44, the tag 14, and a light source 48. The vision sensor 44 and light source 48 are disposed on opposite sides of the tag 14, such that when the vision sensor 44 is disposed on a front (rear) side of the tag 14 the light source 48 is disposed on a rear (front) side of the tag 14.

As shown in FIG. 3, some of the light 46 emitted by the light source 48 passes through the thru-holes 38 of the tag 14, thereby causing the thru-holes 38 to appear brighter than the plate 28. Other portions 46b of the light 46 are reflected by the tag 14. The vision sensor 44 detects the light 46a that passes through the thru-holes, and hence a contrast between the thru-holes 38 and the plate 28. The pattern of the light 46a detected by the vision sensor 44 (i.e., the 2-D bar code) is then converted by a computer (not shown) into data that is used to identify the tag 14, and can be utilized by the manufacturing facility for tracking or other purposes.

FIG. 4 includes the vision sensor 44, tag 14, and light source 48. The vision sensor 44 and light source 48 are disposed on the same side of the tag 14. More particularly, the light source 48 and vision sensor 44 are at an angle to the front side 34 of the tag 14.

As shown in FIG. 4, a portion 46a of the light 46 emitted from the light source 48 toward the tag 14 passes through the thru-holes 38 of the tag 14, while the remainder 46b of the light 46 bounces off of the tag 14 and is received by the vision sensor 44. Thus, of the light signal 46b received by the vision sensor 44, the areas corresponding to the thru-holes appear as dark spots. The vision sensor 44 detects the light 46b, and the pattern of dark spots. The pattern of dark spots detected by the vision sensor 44 (i.e., the 2-D bar code) is then converted by a computer (not shown) into data to identify the tag 14.

As described hereinabove, the present invention solves many problems associated with previous marking systems. However, it will be appreciated that various changes in the details, materials and arrangements of which have been herein described and illustrated in order to explain the nature of the invention, may be made by those skilled in the art without departing from the principle and scope of the invention, as expressed in the appended claims.

What is claimed is:

1. A two-dimensional bar code tag, comprising:
a plate having machine readable indicia, wherein said machine readable indicia is a plurality of thru-holes extending through the plate and arranged in a pattern defining a two-dimensional bar code that can be read from both a front side and a rear side of the plate.

2. The two-dimensional bar code tag of claim 1, wherein the plate further comprises human readable indicia that is one or more openings in a pattern to create at least one of a letter, number, or symbol that can be read from at least one of the front side or the rear side of the plate.

3. The two-dimensional bar code tag of claim 1, wherein the tag is formed from a material that is heat and corrosion resistant.

4. The two-dimensional bar code tag of claim 1, wherein the plate is made of stainless steel.

5. A two-dimensional thermally resistant bar code tag, comprising:
a stainless steel plate, comprising:
machine readable indicia, wherein said machine readable indicia is a plurality of thru-holes extending through said plate and arranged in a pattern to create a two-dimensional bar code that can be read from both a front side and a rear side of the plate; and
human readable indicia, wherein said human readable indicia is one or more openings formed through the plate and arranged in a pattern defining at least one of a letter, number, or symbol that can be read from both the front side and the rear side of the plate.

6. An identifiable bin, comprising:
a basket; and
a plate having a plurality of thru-holes formed therein, wherein the thru-holes are arranged in a pattern that defines a two-dimensional bar code.

7. The identifiable bin of claim 6, wherein the plate further comprises human readable indicia that is one or more openings in a pattern defining at least one of a letter, number, or symbol that can be read from both the front side and the rear side of the plate.
